(19) United States
(12) Patent Application Publication
(10) Pub. No.: US 2002/0114346 A1
(43) Pub. Date: Aug. 22, 2002

(54) Selective modem negotiation operation for data reporting calls

(75) Inventors: Steve C. Lampe, Ft Calhoun, NE (US); Eric A. Blomberg, Omaha, NE (US)

Correspondence Address: Andre M. Szuwalski, Jenkens & Gilchrist, P.C., 1445 Ross Avenue, Suite 3200, Dallas, TX, 75202-2799, US

(73) Assignee: Nexterna, Inc.

(21) Appl. No.: 09/790,288

(22) Filed: Feb. 21, 2001

(51) Int. Cl. H04J 3/16; H04L 5/16

(52) U.S. Cl. 370/465; 375/222

(57) ABSTRACT

A modem for a mobile client is configured to operate either in a primary operational configuration or a secondary operational configuration. When in the primary operational configuration, the modem initiates set-up of a communication toward a remote server and utilizes a fixed data rate and a fixed set of features. No modem negotiation procedure is implemented with respect to the setting up of this communication. If the set-up of the communication at the fixed data rate and with a fixed set of features fails, the modem falls-back to the secondary operational configuration and initiates set-up of a communication toward the remote server using conventional modem negotiation procedures in order to agree on the data rate and set of features to be used for the communication. In association with the server, a primary modem pool is provided to handle mobile client modem communications at the fixed data rate and with a fixed set of features specified by the primary operational configuration. With respect to the secondary operational configuration, on the other hand, a secondary modem pool associated with the server handles mobile client communications at a conventional procedure negotiated data rate and set of features.

### BACKGROUND OF THE INVENTION

1. Technical Field of the Invention

The present invention relates to data communication over a telecommunications link and, in particular, to modem negotiation operation with respect to the setting up of a data communication.

2. Description of Related Art

A simple form of wireless data communication now in common use is data transmission using modems over wireless analog communications links (like those provided by conventional cellular and group mobile radio networks). An illustration of such a system for wireless data communication is shown in FIG. 1. Data terminal equipment (DTE) 10 at a mobile platform 12 is connected to an RF modem 14 using a digital interface. The RF modem 14 communicates over an analog RF air interface 16 (such as an advanced mobile phone service (AMPS) interface or a group mobile radio interface) with a fixed radio base station 18. The base station 18 is part of a wireless communications network 20 that is connected to the public switched telephone network (PSTN) 22. A modem 24 is connected to the PSTN 22 and is further connected over a digital interface to a computer 26 (perhaps comprising a server). In this configuration, the data communication between the DTE 10 and server 26 is in analog format between the modem 14 and modem 24, and is in digital format at all other locations. As an alternative, the wireless communications network 20 may include a modem pool 28 that is connected to a public packet data network 30. The computer 26 (again, perhaps comprising a server) is then connected to the network 30. In this configuration, the data communication between the DTE 10 and server 26 is in analog format between the modem 14 and modem pool 28, and is in digital format at all other locations.

The data rate at which modems may communicate varies due to both the physical limitations of the device itself and the quality of the communications link or links interconnecting the two modems. For example, one modem may have a maximum operational data rate of 2400 bps while another modem may have a maximum operational data rate of 9600 bps. When these modems communicate with each other, they must do so at best using the lower of the two maximum operational data rates. As another example, the air interface 16 connection supporting the interconnection of two modems for communication may be severely interfered and support a maximum communications data rate of 1200 bps. If the foregoing two modems were to communicate over that interconnection, they would be limited to operation at the 1200 bps data rate, in spite of the fact that each modem was physically capable of operating at a faster data rate.

It is further recognized that interconnected modems may possess different performance improving operational features. Examples of such features include error control and data compression. It is important that each connected modem possess the same, compatible or equivalent features in order for the features to be made available to the user. If not, then neither modem should make use of an incompatible or non-supported feature. For example, one modem may support data compression while another does not. When these modems communicate with each other, they must do so without using any sort of data compression techniques.

Because neither modem knows at the time of making initial contact (i.e., at call or communication set-up) either (a) the maximum possible data rate available for the communication interconnection or (b) the commonly-held device supported operational features, the two modems must first agree upon a common data rate and common features to be used for the communication. The method by which the two modems agree upon these matters at set-up is commonly referred to as “handshaking” or “negotiation.” At the start of the communications interconnection between two modems, one of the modems proposes a data rate and its supported operational features. The second modem responds to the proposal with either an acceptance (if the data rate and features are supported by that modem) or a counter-proposal specifying its suggested data rate and features. If accepted, modem negotiation ends and the modems proceed with their communication using the originally proposed data rate and set of features. If a counter-proposal is offered, negotiation continues between the two modems until agreement is reached on the data rate and set of features to be used thereafter for the communication.

Those skilled in the art recognize that completion of the modem negotiation operation during the call set-up process can take many seconds to complete. While this delay is not of significant concern when the subsequent modem supported data communication is lengthy (as would be experienced with a facsimile transmission or large data file transfer), the negotiation delay becomes a more significant concern when the data communication is a short transmission implicating the sending of only a few tens of bytes of data. In this circumstance, it is not unusual for the negotiation process during call set up to take longer than the actual data communication transmission itself. Given the significant expense of purchasing air time over the air interface 16, the added delay in completing the data communication that is imposed by the modem negotiation period during set-up significantly increases the direct cost of each individual data communication. Furthermore, given a system operation with many users and hundreds of potential communications from those users per day, a reduction in the time required for modem negotiation could make a significant positive impact on the user's direct cost of engaging in data communications.

There also exist some indirect costs associated with the length of the data communication that need to be considered. These costs concern the sizing of the modem resources (such as the modem pool 28) provided to assist in remote data reporting. If each communication takes a significant amount of time to complete, and there are many users trying to make reports, the remote modem pool 28 must be dimensioned to handle this traffic. When communication times are reduced, however, a corresponding decrease in modem capacity (and hence the cost of purchasing and maintaining such equipment) is experienced.

### SUMMARY OF THE INVENTION

A modem has a primary operational configuration wherein it initiates set-up of a remote communication utilizing a fixed data rate. No modem negotiation procedure is implemented with respect to setting up this communication and selecting the data rate. If the set-up of the communication at the fixed data rate fails, modem operation falls-back to a secondary operational configuration. In this configuration, the modem initiates set-up of the remote communication using conventional modem negotiation procedures in order to agree on the data rate to be used for the communication.

The foregoing modem operates in a communications system where the remote communication is established with a server. A primary modem pool is provided in association with the server to handle modem primary operational configuration communications at the fixed data rate. Like the modem, the modem pool does not engage in any modem negotiation procedure with respect to setting up the communication and selecting the data rate. A secondary modem pool is also provided in association with the server to handle modem secondary operational configuration communications at an agreed upon data rate selected through conventional modem negotiation procedures.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1, previously described, is a block diagram of a system for wireless data communication;

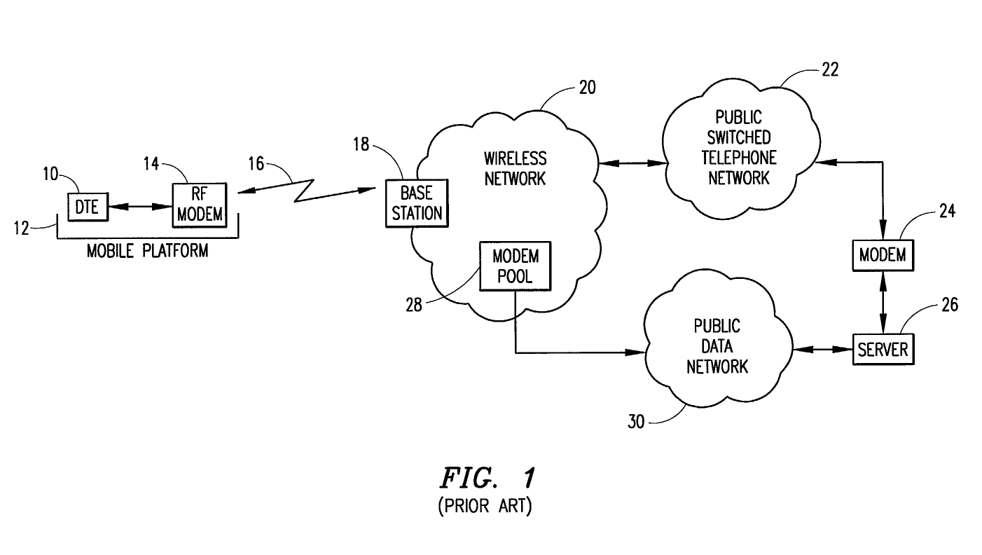

FIG. 2 is a block diagram illustrating an operational environment within which the present invention provides for selective modem negotiation; and

FIG. 3 is a flow diagram illustrating modem operation in accordance with the present invention.

### DETAILED DESCRIPTION OF THE DRAWINGS

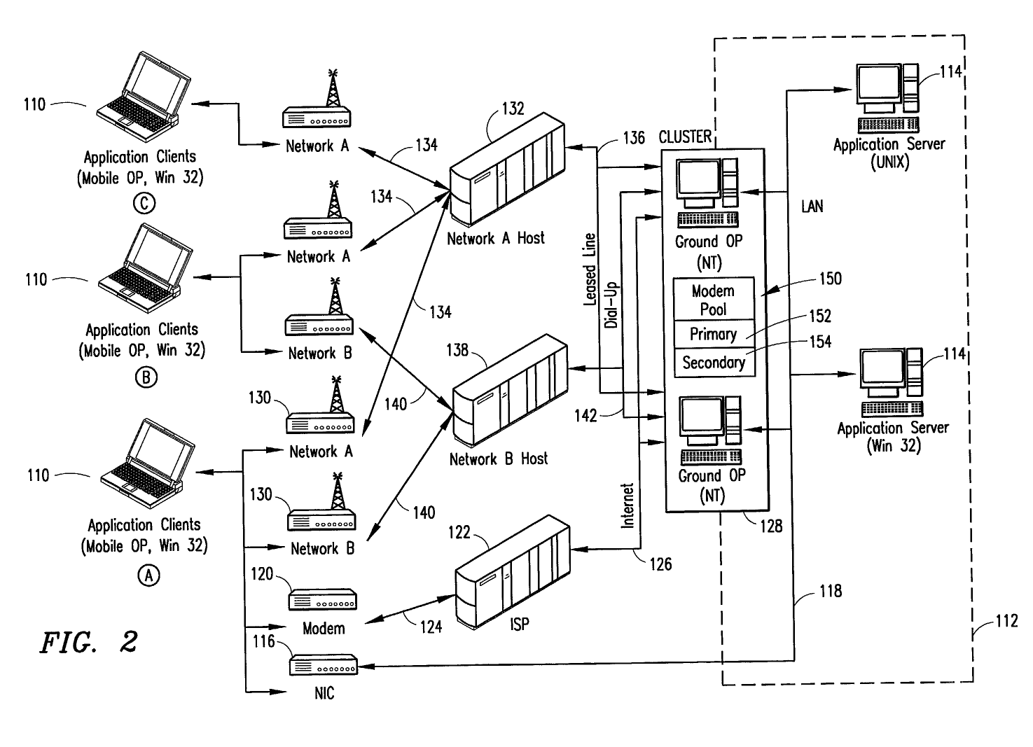

Reference is now made to FIG. 2 wherein there is shown a block diagram illustrating an operational environment within which the present invention provides for selective modem negotiation. Consider the existence of a plurality of mobile clients (illustrated as laptop computers) 110 belonging to a certain organization 112 and needing to be in communication (both wired and wireless) with an application server (or servers) 114 of the organization. The environment provides a number of means (media) for enabling the mobile clients 110 to gain data communications access to the servers 114. In a wireline context, the mobile client 110 may utilize its network interface card (NIC) 116 to gain access to the servers 114 over a local area network (LAN) 118 provided by the organization. Also in a wireline context, the mobile client 110 may utilize its modem 120 to access an internet service provider (ISP) 122 over the public switched telephone network 124 and communicate with the servers 114 over the Internet 126 through a cluster 128 acting as an interface between the Internet connection and the local area network 118. In a wireless context, the mobile client 110 may utilize its radio interface 130 to access a first host 132 over a corresponding first wireless data network 134 and communicate with the servers over a leased line connection 136 through the cluster 128 acting as an interface between the leased line connection and the local area network 118. Similarly, the mobile client 110 may utilize its radio interface 130 to access a second host 138 over a corresponding second wireless data network 140 and communicate with the servers over a dial-up connection 142 through the cluster 128 acting as an interface between the dial-up connection and the local area network 118.

Each mobile client 110 includes a network management functionality that supports ubiquitous connectivity of the mobile client to the servers (with respect to both wired and wireless data networks). This functionality allows a mobile client to seamlessly roam between wired and wireless networks. Furthermore, the functionality allows the mobile client to seamlessly move in out of the coverage areas of various networks (both wired and wireless). Still further, the functionality allows the mobile client to simultaneously use multiple networks. By this it is meant that multiple applications running on a single mobile client can share access to and use of a single data network for communication with the servers, or alternatively can use different networks at the same time. Additionally, this means that the same application can use multiple networks at the same time for the communication of the same or different messages with the servers. The operation of the network management functionality is described in greater detail in co-pending commonly assigned United States Application for patent Ser. No. ______ entitled “System and Method for Dynamically Routing Messages Transmitted from Mobile Platforms” by Tennison, et al., the disclosure of which is hereby incorporated by reference.

Consider now the mobile client 110 positioned at location A. At this location, the mobile client has communications access to the local area network, its Internet service provider (ISP), and the first and second wireless data networks. On a message by message basis, the network management functionality determines which wired and/or wireless data networks should be used to effectuate communications with the servers for that message. That selection operation may take into account a number of factors including: geographic coverage, network availability, allowable latency for message delivery, message size, data security, data integrity and the cost of sending the message across the network. Turning next to the mobile client positioned at location B, more limited data communications access options are available. Here, the mobile client only has access to the first and second wireless data networks. Notwithstanding these access limitations, on a message by message basis, the network management functionality determines which wireless data network(s) (i.e., media) should be used to effectuate communications with the servers. That selection operation take into account the same factors mentioned previously, and may involve choosing to wait until a more favorable network (medium) becomes available. Moving on to the mobile client positioned at location C, it appears that only access to the first wireless data network is available. Again, the factors are taken into account in making a determination whether to engage in the data communication with the server over the only available data network, or alternative delay transmission until a more favorable network (medium) becomes available. In each case it may be recognized that the network management functionality effectively evaluates and considers the immediate conditions affecting individual message transmission at the time of message sending and then selects, from amongst the available wired and/or wireless data networks, the best (i.e., most desirable) network to handle the transmitted message. This selection action is made based on a set of programmable rules that allow for consideration of multiple networks in a simultaneous fashion (using a sort of parallel execution/consideration process).

The cluster 128 includes a modem pool functionality 150 comprising a primary modem pool 152 and a secondary modem pool 154. In the primary modem pool 152, the data rate and features to be used for data communication are fixed. By “fixed” it is meant that they are not subject to negotiation and subsequent change in the context of a call set-up. These fixed selections for the communication data rate and features are chosen based on some assumptions concerning the commonly held capabilities of the modems 130 utilized by the mobile clients 110 as well as some assumptions concerning the quality of the air interface connections 134 and 140. In the secondary modem pool 154, on the other hand, the data rate and features to be used for data communication are susceptible to conventional modem negotiation determination and selection during call set-up while taking into account the unique capabilities of the modems 130 and the currently experienced quality of the air interface connections 134 and 140.

The modems 130 in the mobile clients 110 have a primary operational configuration wherein no modem negotiation operations are performed during call set-up. The modems 130 further include a secondary operational configuration wherein modem negotiation is permitted during call set-up. In configuring the modems 130, operation in the primary operational configuration is set to force the modem to contact the primary modem pool 152 (which is similarly configured in a manner to preclude performance of modem negotiation operations) at call set-up. Operation in the secondary operational configuration, on the other hand, is set to force the modem to contact the secondary modem pool 154 (which is similarly configured in a manner to permit negotiation of data rate and features) at call set-up.

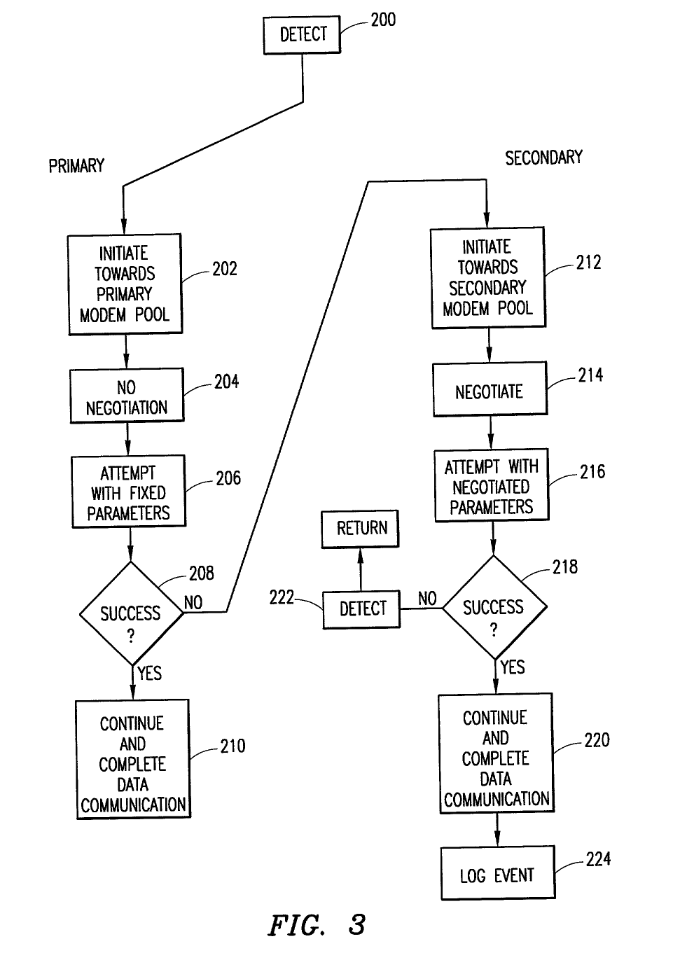

Reference is now additionally made to FIG. 3 wherein there is shown a flow diagram illustrating modem operation in accordance with the present invention. In step 200, the modem 130 detects a need to engage in a data communication over the air interface 134 or 140. The selection of which air interface 134 or 140 (or for that matter which connection 118 or 124) to use for the data communication is made in accordance with the actions of the network management functionality taken in the manner taught by the disclosed process of the above-referenced co-pending application for patent). This detection step 200 is likely made responsive to mobile client 110 initiation of a data call toward the server 114. Responsive to operation in the primary operational configuration, the modem 130 initiates a connection towards the primary modem pool 152 in step 202 (i.e., call set-up). As discussed above, when contact is made with the primary modem pool 152 in the primary operational configuration no negotiation of modem data rate or features is made during the course of setting up the call (step 204). Instead, the modem 130 and primary modem pool 152 attempt to use (step 206) for the call the fixed data rate and feature selections (parameters) that were pre-chosen for use by the primary modem pool for all data communications.

If the initiated data communication call set-up at the selected fixed data rate and features is successful (as determined in decision step 208), the data communication call continues in step 210 at the fixed data rate and using the preselected features over the air interface between the modem 130 and modem pool 152 until subsequently terminated by either party. One noted benefit of operation in this manner is a saving of the time during call set-up that is needed to finish modem negotiation and move on to engaging in the actual data communication itself. With this process, the overall data communication transaction is completed much more quickly (because set-up takes less time) and the user is accordingly not charged as much money for use of the expensive air interface 134 or 140.

If, on the other hand, the initiated data communication call set-up at the selected fixed data rate and features is not successful (as determined in decision step 208), the modem 130 switches in step 212 to operation in the secondary operational configuration where the modem 130 initiates a connection towards the secondary modem pool 154. This implements a form a communications exception handling. As discussed above, when contact is made with the secondary modem pool 154 in the secondary operational configuration a conventional call set-up negotiation of modem data rate or features is made (step 214). The modem 130 and secondary modem pool 154 then attempt to use (step 216) the negotiated data rate and feature selections (parameters). If the initiated data communication at the selected fixed data rate and features is successful (as determined in decision step 218), data communication continues in step 220 at the negotiated data rate and using the negotiated features over the air interface between the modem 130 and modem pool 154 until subsequently terminated by either party. Otherwise, the modem 130 rejects the data communication in step 222 and waits until a later time to retry (by returning to step 200).

If the secondary modem pool 154 is used for communication in step 220, a record of this event is kept by the server in a modem log (step 224). The log contains information concerning the mobile client whose modem 130 was involved in the communication in the secondary operational configuration. Record is also kept in the log of the time of day and date of the event. Information concerning the wireless connection (such as mobile client location, loading, interference, and the like) as, and if, supplied by the wireless data network may also be stored in the log. The log recorded information is then post-processed by the server to identify any particular modems 130 that consistently or chronically are unable to perform at the fixed data rate and/or fixed features of the primary operational configuration. Other post-processing activities may also be performed with respect to the logged information to detect operational difficulties (such as problem geographic areas or times of day). As a result of the processing, a fine tuning of operation of the communications system may be made. For example, reporting times and intervals may be changed, fixed data rates and features may be adjusted, and defective modems may be scheduled for repair or replacement.

Given a reduction in overall communication time for making data communication reports that is due, at least in part, to a reduction in the length of time needed to engage in modem negotiation procedures with the primary modem pool, the present invention allows for a reduction in costs due to both decreased air time charges and a smaller dimensioning of the primary modem pool resources. It is further recognized that the system may be scaled to support dozens, hundreds or even thousands of mobile clients. It is imperative that these mobile clients do not simultaneously (or even substantially simultaneously) attempt to make data communications towards the primary modem pool. If this occurred, primary modem pool access would frequently fail and place an undue burden on the secondary modem pool with a corresponding increase in air time cost due to modem negotiation during exception handling. Appropriate individual control over the timing of mobile client reporting actions to the primary modem pool is accordingly taken utilizing the techniques disclosed in commonly assigned, co-pending application for patent Ser. No. ______ entitled “Collecting and Reporting Information Concerning Mobile Assets” by Tennison, et al., the disclosure of which is hereby incorporated by reference. As disclosed therein, many temporally distinct pieces of data are collected and sent in a single communication. This serves to reduce the number of reports each mobile client makes (thus decreasing air time charge and reducing modem pool loading). Furthermore, over a plurality of mobile clients, these data reports are staggered in accordance with a per-client randomly (or pseudo-randomly) chosen offset that effectively reduces the load experienced by the primary modem pool in connection with the handling of data communication reports, and maximizes the chances that the primary modem pool (with reduced air time cost), instead of the secondary modem pool, will be used for the communication report. Given this configuration and reporting procedure, a corresponding reduction in the dimensioning (i.e., cost reduction) of the secondary modem is also achieved as these resources will only be utilized to handle a small volume of exception reports.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A modem having a primary operational configuration wherein remote communications are set-up without the use of conventional modem negotiation procedures to select communication data rate and subsequent remote communications occur utilizing a pre-agreed, fixed data rate, and further having a secondary operational configuration wherein remote communications are set-up using conventional modem negotiation procedures to select a communication data rate and subsequent remote communications occur utilizing that selected data rate, the modem operating first in the primary operational configuration and then switching to the secondary operational configuration if communication at the fixed data rate fails.

2. The modem of claim 1 wherein the modem further operates to contact for call set-up in accordance with the primary operational configuration a first modem with which pre-agreement as to the fixed data rate has been made.

3. The modem of claim 2 wherein the first modem comprises a modem pool associated with a server.

4. The modem of claim 2 wherein the modem further operates to contact for call set-up in accordance with the secondary operational configuration a second modem in order to engage in modem data rate negotiation.

5. The modem of claim 4 wherein the first modem comprises a first modem pool associated with a server and the second modem comprises a second modem pool associated with the same server.

6. The modem of claim 1 wherein remote communications in the primary operational configuration are set-up without the use of conventional modem negotiation procedures to select communication data rate and remote communications occur utilizing both a pre-agreed, fixed data rate and a pre-agreed, fixed set of communication features.

7. The modem of claim 6 wherein remote communications in the secondary operational configuration are set-up using conventional modem negotiation procedures to select both a communication data rate and a set of communication features, and remote communications occur utilizing the selected data rate and selected set of communication features.

8. The modem of claim 7 wherein the pre-agreed or selected set of communication features includes at least one modem communication feature selected from the group consisting of: data compression and error correction.

9. A method for modem operation during call set-up, comprising the steps of:
detecting a need to set-up a call towards a server;
initiating communication towards a first modem associated with the server without the use of conventional modem negotiation procedures to select communication data rate in order to engage in remote communications utilizing a fixed data rate that is pre-agreed upon with the first modem; and
if the foregoing communications fail, then initiating communication towards a second modem also associated with the server using conventional modem negotiation procedures to select communication data rate in order to engage in remote communications utilizing that selected data rate.

10. The method of claim 9 wherein the step of initiating communication towards the first modem is made without the use of conventional modem negotiation procedures and remote communications occur utilizing both a pre-agreed, fixed data rate and a pre-agreed, fixed set of communication features.

11. The method of claim 10 wherein the step of initiating communication towards the second modem is made using conventional modem negotiation procedures to select both a communication data rate and a set of communication features, and remote communications occur utilizing the selected data rate and selected set of communication features.

12. The modem of claim 11 wherein the pre-agreed or selected set of communication features includes at least one modem communication feature selected from the group consisting of: data compression and error correction.

13. The modem of claim 9 wherein the first modem comprises a first modem pool associated with the server and the second modem comprises a second modem pool associated with the same server.

14. A communications system, comprising:
a server;
a first modem associated with the server and whose data rate for communication is fixed;
a second modem also associated with the server and whose data rate for communication is subject to selection by modem negotiation;
a mobile client;
a modem associated with the mobile client and having a primary operational configuration wherein remote communications with the server are set-up through the first modem without the use of conventional modem negotiation procedures utilizing the fixed data rate, and further having a secondary operational configuration wherein remote communications with the server are set-up through the second modem using conventional modem negotiation procedures to select a communication data rate and remote communications occur utilizing that selected data rate.

15. The system of claim 14 wherein the modem associated with the mobile client operates first in the primary operational configuration and then switches to the secondary operational configuration if communication at the fixed data rate fails.

16. The system of claim 14 wherein the first modem comprises a first modem pool associated with the server and the second modem comprises a second modem pool associated with the server.

17. The system of claim 14 wherein remote communications in the primary operational configuration are set-up without the use of conventional modem negotiation procedures utilizing both the fixed data rate and a fixed set of communication features.

18. The system of claim 17 wherein remote communications in the secondary operational configuration are set-up using conventional modem negotiation procedures to select both the communication data rate and a set of communication features, and remote communications occur utilizing the selected data rate and selected set of communication features.

19. The system of claim 18 wherein the pre-agreed or selected set of communication features includes at least one modem communication feature selected from the group consisting of: data compression and error correction.

20. The system of claim 14 further including means for logging information relating to instances of mobile client modem communication with the second modem.
